(19) United States
(12) Patent Application Publication
(10) Pub. No.: US 2011/0157020 A1
(43) Pub. Date: Jun. 30, 2011

(54) TOUCH-CONTROLLED CURSOR OPERATED HANDHELD ELECTRONIC DEVICE

(75) Inventors: Chung-Shao Huang, Taipei (TW); Ching-Feng Hsieh, Taipei (TW)

(73) Assignee: ASKEY COMPUTER CORPORATION, Taipei (TW)

(21) Appl. No.: 12/729,689

(22) Filed: Mar. 23, 2010

(30) Foreign Application Priority Data
Dec. 31, 2009 (TW) 098146222

(51) Int. Cl. G09G 5/08; G06F 3/041

(52) U.S. Cl. 345/167; 345/157; 345/173

(57) ABSTRACT

Proposed is a touch-controlled cursor operated handheld electronic device, including a main housing, a display screen disposed on the main housing, and a touch-control member disposed on the main housing at a position opposite to the display screen with respect to the main housing. The display screen displays a touch-control interface including application program activating icons and a cursor. The cursor is configured to at least touch-control the application program activating icons of the touch-control interface. The application program activating icons are configured to start and execute associated application programs. The cursor on the touch-control interface is touch-controlled and operated by the touch-control member.

### BACKGROUND OF THE INVENTION

1. Field of the Invention

The present invention relates to handheld electronic devices, and more particularly, to a handheld electronic device operated by a touch-controlled cursor.

2. Description of the Prior Art

Handheld electronic devices for use with digital communication systems, such as cell phones and vehicle navigation systems, have become nearly indispensable to modern life.

In general, users select functions offered by handheld electronic devices and operate the handheld electronic devices by means of functional keys provided thereon. Take a cell phone as an example, a user presses directional keys, alphanumeric keys and the “enter” key to send or receive a message, set a use mode, browse a list of contacts, turn on the photographic function, etc. Furthermore, given the emergence of touch panels and maturation of related technology, a user can also use a finger or a stylus to operate a handheld electronic device equipped with a touch panel.

To enhance portability of handheld electronic devices, handheld electronic device manufacturers endeavor to develop compact handheld electronic devices with miniaturized touch panels. The coordinates of the touch panels of this kind of devices are determined mostly by the absolute position of a touch contact thereon. Due to the generally small area of a touch panel, a user is likely to make entry errors when using his/her finger or a stylus in operating a handheld electronic device equipped with a touch panel. Also, using a stylus to operate a handheld electronic device equipped with the touch panel is rather inconvenient, because doing so precludes single-handed operation since one hand holds the device and another hand holds the stylus. Last but not least, it is not uncommon for stylus to be lost or damaged.

In view of the aforesaid drawbacks of the prior art, it is imperative to provide a handheld electronic device that is operable single-handedly, easily, and precisely.

### SUMMARY OF THE INVENTION

In light of the aforesaid drawbacks of the prior art, it is an objective of the present invention to provide a handheld electronic device operable single-handedly, easily, and precisely.

To achieve the above and other objectives, the present invention provides a touch-controlled cursor operated handheld electronic device, comprising: a main housing comprising a memory unit for storing a plurality of application programs and a cursor-controlling software; a display screen provided on the main housing for displaying a touch-control interface comprising a plurality of application program activating icons and a cursor, the application program activating icons being configured to start executing the application programs, and the cursor being displayed according to the cursor-controlling software; and a touch-control member, provided on the main housing at a position opposite to the display screen with respect to the main housing, and configured for touch-control operation of the cursor on the touch-control interface.

In an embodiment of the present invention, the touch-controlled cursor operated handheld electronic device further comprises an activation unit provided on the main housing at a position proximate to the display screen, and configured to start operation as soon as the cursor on the touch-control interface points to a corresponding one of the application program activating icons. In this embodiment, the activation unit is a switch or a push-button and comprises an execution key and a selection key.

In another embodiment of the present invention, the touch-controlled cursor operated handheld electronic device further comprises an activation unit provided on the main housing at a position proximate to the display screen, and configured to start operation as soon as the cursor on the touch-control interface points to a corresponding one of the application program activating icons. Preferably, the activation unit is positioned proximate to the touch-control member.

In conclusion, the present invention provides a handheld electronic device operated by a touch-controlled cursor characterized in that: a user can move and operate a cursor on a touch-controlled screen by means of a touch-control member; and after the cursor on the touch-controlled screen moves and points at a corresponding one of application program activating icons on the touch-control interface, the user can start an intended application program not only by hitting the touch-control member repeatedly but also by pressing or pushing the activation unit. Hence, it is easy to operate the touch-controlled cursor operated handheld electronic device of the present invention with precision.

### BRIEF DESCRIPTION OF THE DRAWINGS

FIG. 1A is a front perspective view of an embodiment of a touch-controlled cursor operated handheld electronic device according to the present invention;

FIG. 1B is a rear perspective view of the touch-controlled cursor operated handheld electronic device shown in FIG. 1A according to the present invention; and

FIG. 2 is an illustrative diagram of a touch-control interface displayed by a display screen in another embodiment of the touch-controlled cursor operated handheld electronic device according to the present invention.

### DETAILED DESCRIPTION OF THE EMBODIMENTS

The present invention is herein illustrated with specific embodiments; one skilled in the pertinent art can easily understand other advantages and effects of the present invention from the disclosure of the invention.

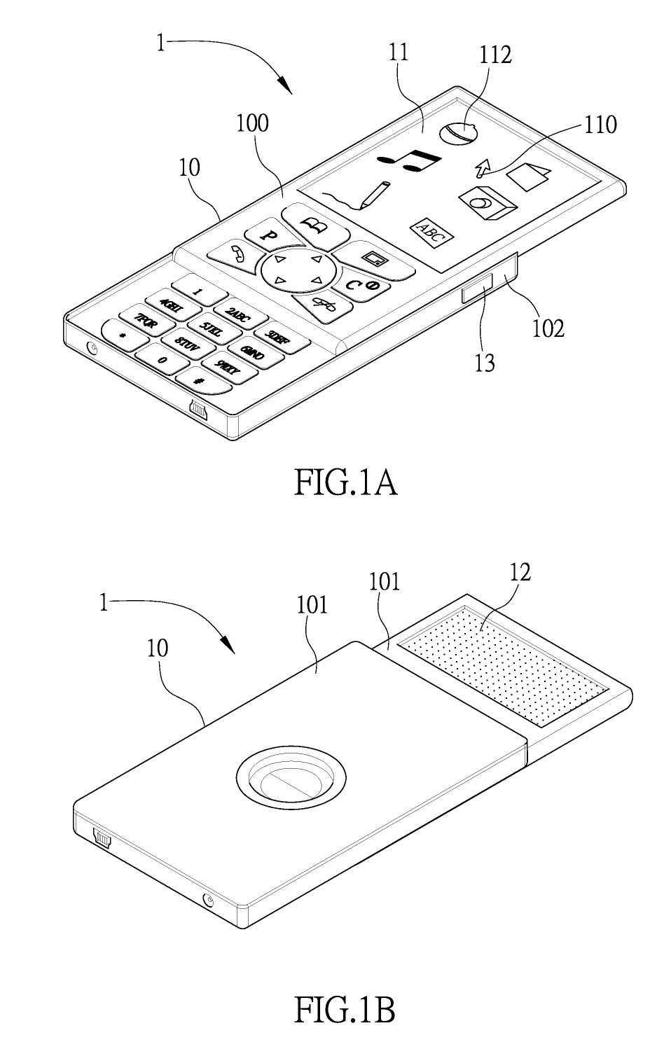

Referring to FIG. 1A and FIG. 1B, shown are front and rear perspective views of an embodiment of a touch-controlled cursor operated electronic device 1 according to the present invention, respectively. In this embodiment, the touch-controlled cursor operated handheld electronic device 1 is a sliding-cover cell phone, though it is not limited thereto; for example, it can be a so-called “candy bar” or foldable (clamshell) cell phone. In another embodiment, the handheld electronic device operated by a touch-controlled cursor 1 is a personal digital assistant (PDA) or a navigation device.

As shown in FIG. 1A and FIG. 1B, in this embodiment, the touch-controlled cursor operated handheld electronic device 1 comprises a main housing 10, a display screen 11, a touch-control member 12, and an activation unit 13.

The main housing 10 comprises a memory unit (not shown) for storing a plurality of application programs and cursor-controlling software. For example, the application program functions as a means to provide a conversation log, list of contact persons, music player, message composer, camera, or mode/setup configuration menu.

The display screen 11 is provided on the main housing 10 for displaying a touch-control interface comprising a cursor 110 and a plurality of application program activating icons 112. The application program activating icons 112 are configured to start executing the application programs. The cursor 110 is displayed according to the cursor-controlling software. In this embodiment, the display screen 11 is a liquid crystal display (LCD) screen or a touch panel and is provided on the front 100 of the main housing 10. The cursor 110 is, for example, shaped like an arrow (as shown in FIG. 1A), a line, a circle, or a frame.

The touch-control member 12, opposite the display screen 11, is provided on the rear 101 of the main housing 10 and configured for touch-control of the cursor 110 on the touch-control interface. In this embodiment, a user holding the main housing 10 single-handedly is able to operate the touch-control member 12 with a finger so as to controllably operate a corresponding one of the application program activating icons 112 displayed by the display screen 11, because the finger, such as an index finger, is positioned on the rear 101 of the main housing 10. Moreover, the cursor 110 on the touch-control interface of the display screen 11 moves across the touch-control interface in response to the movement of the touch-control member 12 by the user's finger and according to the cursor cursor-controlling software stored in the memory unit. The touch-control member 12 is not limited to the touch panel shown in FIG. 1B. For example, the touch-control member 12 can also be a miniature track ball (not shown) or other sensing mechanism, such as an optical sensor. That is, the touch-control member 12 is not strictly limited to touch sensing but rather senses the movement of a finger or, as with a track ball, moves in response thereto. In this embodiment, the touch-control area provided by the touch-control member 12 is not limited to the one shown in FIG. 1B; instead, the touch-control area provided by the touch-control member 12 can be smaller or larger than the one shown in FIG, of a different shape and/or in a different location. 1B. In other words, the design of the touch-control area provided by the touch-control member 12 is subject to changes as needed after giving considerations to the desired size, shape, texture and appearance of the product or other needs.

The activation unit 13 is provided on a side 102 of the main housing 10, positioned proximate to the display screen 11, and configured to start operation as soon as the cursor 110 on the touch-control interface points at a corresponding one of the application program activating icons 112. In this embodiment, the activation unit 13 is provided on the side 102 and is a button, but is not limited thereto. Alternatively, the activation unit 13 is a switch with the same function. Hence, when the cursor 110 on the touch-control interface moves in response to the user's touch-control of the touch-control member 12 and points at a corresponding one of the application program activating icons 112 on the touch-control interface, the user can use the activation unit 13 to start the application program associated with the application program activating icon 112 pointed to by the cursor 110, for example, to start a camera applet/program. In another embodiment, the main housing 10 is not provided with the activation unit 13, and the user can select said application program activating icon 112 pointed at by the cursor 110 without using the activation unit 13, for example, by hitting the touch-control member 12 repeatedly so as to select the intended said application program activating icon 112 pointed to by the cursor 110 on the touch-control interface. In yet another embodiment, the activation unit 13 is provided on the rear 101 of the main housing 10 and positioned proximate to the touch-control member 12.

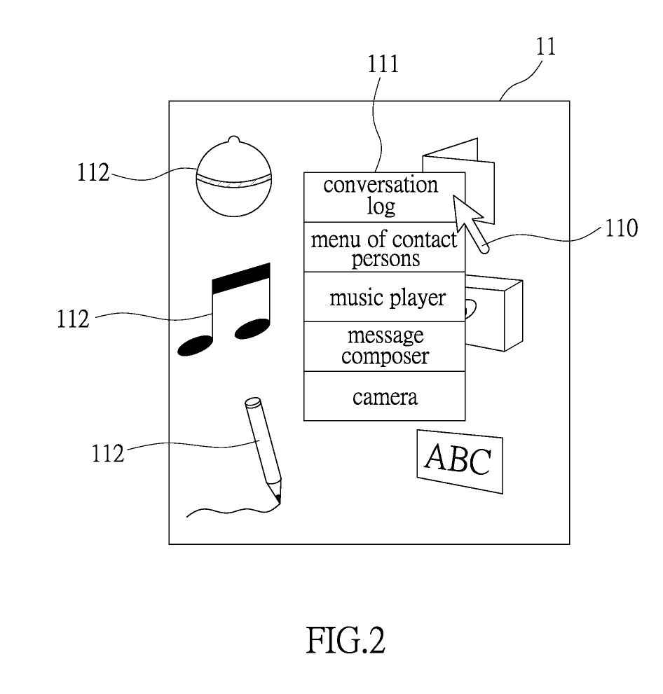

Alternatively, the activation unit 13 comprises two keys (not shown), one configured to function as an execution key whereby the user executes functionality provided by the application program activating icons 112 by making reference to intended said application program activating icon 112 pointed to by the cursor 110, and the other one configured to function as a selection key whereby the user accesses a program menu 111 provided by an application program stored in the memory unit. Hence, as shown in FIG. 2, the user's finger can move across the touch-control member 12 so as to control the stopping position of the cursor 110 on the program menu 111 and, upon correspondence with (arrival at) the intended application program on the program menu 111, operate the execution key provided by the activation unit 13 so as to execute the intended function according to the application program associated with the stopping position selected by the user.

In conclusion, the present invention provides a touch-controlled cursor operated handheld electronic device configured to be single-handedly held by a user, allowing the user's finger to move across the touch-control member on the rear of the touch-controlled cursor operated handheld electronic device to thereby control the position of a cursor displayed on the display screen on the front of the touch-controlled cursor operated handheld electronic device and enable the user to readily determine when an application program or function is selectable as displayed on the display screen. Hence, it is easy to operate the touch-controlled cursor operated handheld electronic device of the present invention with precision. Also, after the cursor on the touch-control interface of the display screen moves as a result of user operation and points at a corresponding one of the application program activating icons on the touch-control interface, the user may start the application program by means of the touch-control member or the activation unit. The touch-controlled cursor operated handheld electronic device of the present invention features a reduction in the possibility of a mis-touch or bad-sensing of touch, because the cursor can be positioned in the absence of absolute coordinates but by means of relative displacement of a finger and the touch-control thereof.

The foregoing descriptions of the detailed embodiments are provided to illustrate and disclose the features and functions of the present invention and are not intended to be restrictive of the scope of the present invention. It should be understood by those in the art that many modifications and variations can be made according to the spirit and principles in the disclosure of the present invention and still fall within the scope of the invention as set forth in the appended claims.

What is claimed is:

1. A touch-controlled cursor operated handheld electronic device, comprising:
a main housing comprising a memory unit for storing a plurality of application programs and a cursor-controlling software;
a display screen provided on the main housing for displaying a touch-control interface comprising a plurality of application program activating icons associated with the plurality of application programs and a cursor, the application program activating icons being configured to start executing the application programs, and the cursor being displayed according to the cursor-controlling software; and
a touch-control member provided on the main housing at a position opposite to the display screen with respect to the main housing, and configured to touch-control and operate the cursor on the touch-control interface.

2. The device of claim 1, further comprising an activation unit provided on the main housing at a position proximate to the display screen, and configured to start operation as soon as the cursor on the touch-control interface points to a corresponding one of the application program activating icons.

3. The device of claim 2, wherein the activation unit is a button or a switch.

4. The device of claim 2, wherein the activation unit comprises an execution key.

5. The device of claim 4, wherein the activation unit further comprises a selection key.

6. The device of claim 1, further comprising an activation unit provided on the main housing at a position proximate to the display screen, and configured to start operation as soon as the cursor on the touch-control interface points to a corresponding one of the application program activating icons.

7. The device of claim 6, wherein the activation unit is positioned proximate to the touch-control member.

8. The device of claim 1, wherein the touch-control member is a touch panel or a track ball.
